(19) United States
(12) Patent Application Publication
(10) Pub. No.: US 2004/0113407 A1
(43) Pub. Date: Jun. 17, 2004

(54) Assembly for mounting an accessory to a vehicle

(76) Inventors: Richard W. McCoy, Granger, IN (US); Thomas W. Lindenman, South Bend, IN (US)

Correspondence Address: KING & SCHICKLI, PLLC, 247 NORTH BROADWAY, LEXINGTON, KY, 40507, US

(21) Appl. No.: 10/470,540

(22) PCT Filed: Oct. 2, 2001
(86) PCT No.: PCT/US01/30778

(51) Int. Cl. B60R 9/00

(52) U.S. Cl. 280/769

(57) ABSTRACT

An assembly (10) for mounting an accessory to a vehicle includes a central frame member (12), a pair of vehicle mounting brackets (30), a first accessory receiver (40) and a first accessory receiver mounting bracket (40) secured to both the first accessory receiver (40) and the central frame member (12). The mounting bracket may assume the form of a single plate or a pair of cooperating plates.

This application claims the benefit of U.S. Provisional Patent Application Serial No. 60/264,417 filed Jan. 26, 2001.

### TECHNICAL FIELD

The present invention relates generally to receiver assemblies and, more particularly, to a receiver assembly incorporating two or more accessory receivers for receiving and holding various useful accessories including but not limited to a bike rack, ski rack, cargo carrier, directable light, flag holder and brush bar.

### BACKGROUND OF THE INVENTION

It has long been known to construct towing hitches that are mounted to vehicles in order to allow the towing of trailers or the like. In recent years such hitches have been designed to include a receiver box having a rearwardly directed opening or cavity for the receipt of a hitch or draw bar that carries a hitch ball or other means allowing connection to a trailer. Examples of such a structure include the Insta-Hitch II and Custom Hitch Receiver 35365 as manufactured by Reese Products, Inc. of Elkhart, Indiana. Such a hitch receiver is also disclosed in, for example, U.S. Pat. No. 3,768,837 to Reese.

Recent efforts to enhance the versatility of a hitch receiver have led to the development of various accessories (e.g., both open and closed article carriers, bike racks, ski racks, tables,.winches or other equipment) mounted by means of an accessory mounting bar in the receiver box of a trailer hitch receiver assembly. Because of their convenience and suitability to the particular applications/interests of the user, such accessories have become very popular.

The present invention relates to an apparatus allowing for or accommodating the mounting of just such an accessory. More specifically, an assembly with one or more accessory receivers is provided.

### SUMMARY OF THE INVENTION

In accordance with the purposes of the present invention as described herein, an improved receiver assembly is provided for towing a trailer behind a towing vehicle. The receiver assembly includes a central frame member and a hitch receiver box carried on the central frame member. The hitch receiver box is adapted to receive a hitch bar or draw bar for towing a trailer.

The receiver assembly also includes vehicle mounting brackets carried on the central frame member that allow the receiver assembly to be secured to the towing vehicle. Additionally, the receiver assembly includes a first accessory receiver and a first accessory receiver mounting bracket secured to the first accessory receiver as well as to the central frame member.

In one embodiment of the present invention the first accessory receiver mounting bracket is a mounting plate having a first slot for receiving the first accessory receiver and a second slot for receiving the central frame member. The first slot is rectangular and the second slot is semicircular. The first slot includes a first axis of symmetry and the second slot includes an axis of symmetry wherein lines A and B along the axes of symmetry define an included angle of between about 20° to about 60° and more typically from about 45° to about 50°.

In a second embodiment the first accessory receiver mounting bracket is a pair of cooperating mounting plates. Each of the pair of cooperating mounting plates includes an aperture for receiving and engaging the first accessory receiver. Additionally, where the central frame member has an outer dimension D, the pair of cooperating plates are spaced apart a distance D corresponding to the outer dimension D whereby the pair of cooperating plates engage opposing points on the central frame member.

In yet another embodiment the first accessory receiver mounting bracket is a pair of cooperating mounting plates wherein each of the pair of cooperating mounting plates includes a first slot for receiving and engaging the central frame member. Each of the first slots is semicircular. Additionally, where the first accessory receiver has an outer dimension D₁, the pair of cooperating mounting plates are spaced apart a distance D₁ corresponding to the outer dimension D₁. In this manner the pair of cooperating plates engage opposing points on the first accessory receiver.

In accordance with yet another aspect of the present invention, multiple accessory receivers are provided on the receiver assembly. Thus, the receiver assembly may be further defined as including a second accessory receiver and a second accessory receiver mounting bracket. The second accessory receiver mounting bracket is secured to the second accessory receiver as well as to the central frame member.

In a first embodiment the second accessory receiver mounting bracket is a mounting plate having a first slot for receiving the second accessory receiver and a second slot for receiving the central frame member. The first slot is rectangular and the second slot is semicircular. The first slot includes a first axis of symmetry A and the second slot includes an axis of symmetry B wherein the axes of symmetry A and B define an included angle of between about 20° to about 60° and more typically about 45° to about 50°.

In a second embodiment the second accessory receiver mounting bracket is a pair of cooperating mounting plates. Each of the mounting plates includes an aperture for receiving and engaging the second accessory receiver. Where the central frame member has an outer dimension D, the pair of cooperating plates are spaced apart a distance D corresponding to the outer dimension D whereby the pair of cooperating plates engage opposing points on the central frame member.

In a third embodiment the second accessory receiver mounting bracket is a pair of cooperating mounting plates. Each of the pair of cooperating mounting plates includes a first slot for receiving and engaging the central frame member. Each of the first slots is semicircular. Where the second accessory receiver has an outer dimension D₁ and the pair of cooperating mounting plates are spaced apart a distance D₁ corresponding to the outer dimension D₁, the pair of cooperating plates engage opposing points on the second accessory receiver.

Still other objects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain the principles of the invention. In the drawing:

FIG. 1 is a perspective view of a first embodiment of the receiver assembly of the present invention holding an accessory;

FIGS. 2a-2b are respective detailed perspective and side elevational views of the accessory receiver mounting bracket of the first embodiment shown in FIG. 1;

FIGS. 3a-3b are respective detailed perspective and side elevational views of an alternative embodiment of the accessory receiver mounting bracket;

FIGS. 4a-4b are respective detailed perspective and rear side elevational views of another alternative embodiment of the accessory receiver mounting bracket;

FIG. 5 is a perspective view of yet another alternative embodiment wherein the assembly includes accessory mounting receivers but no receiver box; and

FIG. 6 is a partially exploded perspective view showing still another alternative embodiment wherein the accessory receiver mounting bracket includes a slot for engaging the central frame member and the wall of the port includes a slot for engaging the body of the mounting bracket.

Reference will now be made in detail to the present preferred embodiments of the invention, examples of which is illustrated in the accompanying drawings.

### DETAILED DESCRIPTION OF THE INVENTION

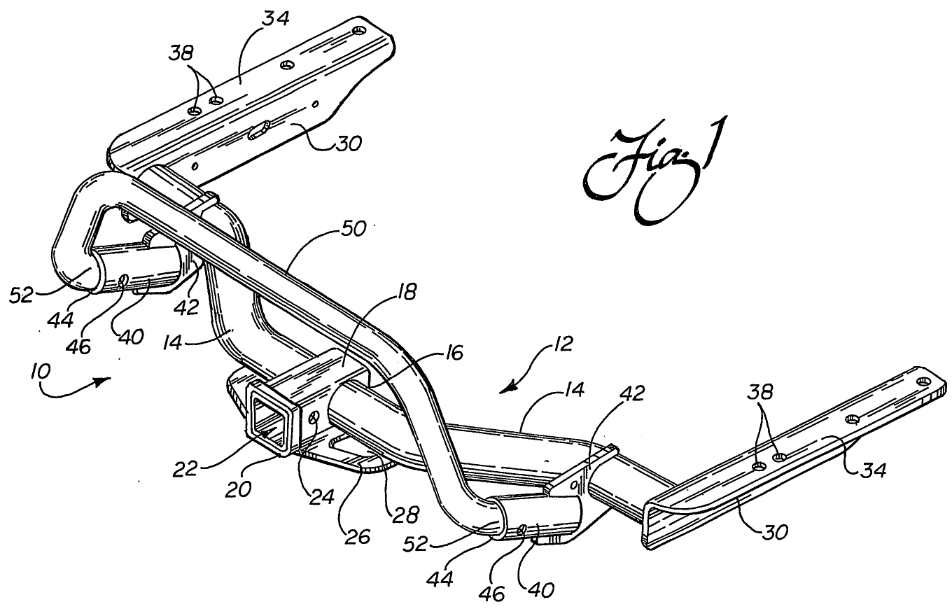

Reference is now made to FIG. 1 showing a receiver assembly 10. The receiver assembly 10 includes a central frame member or cross member 12 preferably formed from a pair of tubular steel sections 14 welded to the opposing side walls 16 of a centrally located receiver box 18 so as to project outwardly in opposing directions. The tubular steel sections 14 may be formed with a round cross section as shown in the drawing figures, a square, elliptical, hexagonal or octagonal cross section or any other appropriate shape providing the necessary strength to function as a trailer hitch assembly.

The receiver box 18 includes a reinforced lip 20 defining an opening leading to a hitch bar receiving cavity 22. Aligned apertures 24 in the opposing side walls 16 of the receiver box 18 allow the secure connection of a hitch bar in the receiver box in a manner well known in the art by means of a connecting pin and cooperating pin clip (not shown). A chain plate 26 is welded to the receiver box 18 and tubular steel sections 14 in order to strengthen the connection. As is known in the art, chain plate 26 includes two apertures 28. The safety chains of a trailer may be connected to the chain plate 26 through engagement in these apertures 28.

Vehicle mounting brackets 30 are mounted adjacent the distal end of each tubular section 14. More specifically, the brackets 30 are welded to the tubular sections 14 in order to complete the connection. The mounting brackets 30 each include a mounting flange 34 with apertures 38. Nut and bolt fasteners (not shown) are extended through these apertures 38 and cooperating apertures drilled in the frame of the towing vehicle in order to mount the receiver assembly 10 thereto.

As also shown in FIG. 1, the receiver assembly 10 incorporates a pair of accessory receivers 40 carried on the tubular sections 14 of the central frame member 12. Each of the accessory receivers 40 is formed from a steel tube that is welded to an accessory receiver mounting bracket 42 that is, in turn, welded to one of the tubular sections 14 so that one accessory receiver is positioned between the receiver box 18 and each mounting bracket 30.

As shown, each accessory receiver 40 includes a circular port or opening 44 and cooperating aligned apertures 46 in the sidewall thereof to allow secure connection of a selected accessory, such as the vehicle body guard or brush bar 50 shown, by means of a connecting pin and pin clip of a type well known in the art (not shown) such as utilized to secure the hitch bar in the receiver box 18. Accessory receiver 40 shown in the drawing as a round cross section may also be square, rectangle or any appropriate shape providing the necessary strength and function.

In use, each of the accessory receivers 40 is oriented with respect to the central frame member 12, receiver box 18 and the towing vehicle upon which the assembly 10 is mounted so as to be readily accessible by the towing vehicle operator. More specifically, the hitch receiver box 18 extends in a substantially horizontal plane and each accessory receiver 40 has a longitudinal axis extending in a second plane projecting upwardly from the plane of the receiver box 18 and frame member 12 at an included angle of about 10° to about 30° and more typically 20°.

The manner in which the structural arrangement of the accessory receivers 40 benefits the user when attempting to attach a recreational and/or utilitarian accessory will now be more completely explained. When the receiver assembly 10 is mounted to the towing vehicle, the sections 14 of the central frame member 12 are positioned directly under the bumper of the vehicle. Both the receiver box 18 and the accessory receivers 40 project from the sections 14 so as to extend to or beyond the rear edge of the bumper. Additionally, the accessory receivers 40 project upwardly at an angle of about 10° to about 30° (e.g., about 20°) with respect to the receiver box 18, the frame member 12 and the horizontal. Thus, the circular ports or openings 44 of the accessory receivers 40 are both readily visible and accessible.

Due to this fact, it is relatively easy for the user to engage the ports or openings 44 of the accessory receivers 40 with the mounting ends 52 of the vehicle body guard or brush bar 50. At this point, the lower lip of the accessory receivers 40 function to support the weight of the accessory 50 as the accessory is being inserted, thereby providing more convenient ease of manipulation. Additionally, the circular shape of the accessory ports or openings 44 and cooperating mounting ends 52 further insure ease of connection. Specifically, since the ends 52 and the openings 44 in the receivers 40 are both round, they present continuous, uninterrupted mating sidewalls. Accordingly, it is not necessary to index the mounting ends 52 in any way to insure proper geometry for mating; simple alignment is all that is necessary. Additionally, the mounting ends 52 may be flexed slightly in virtually any direction during mating as an additional aid when making the connection.

Once properly aligned, the mounting ends 52 slide readily into the receivers 40. When fully seated, cross apertures (not shown) in the ends 52 are in alignment with the apertures 44. A connecting pin (not shown) is then positioned in these apertures and a pin clip (not shown) is used to secure the pin in position. The resulting two point connection through the receivers 40 dramatically increases the stability of the connection between the vehicle body guard or brush bar 50 and the vehicle. Of course, the vehicle body guard/brush bar 50 may be easily removed by removing the pin clips and connecting pins and pulling the ends 52 from the receivers 40.

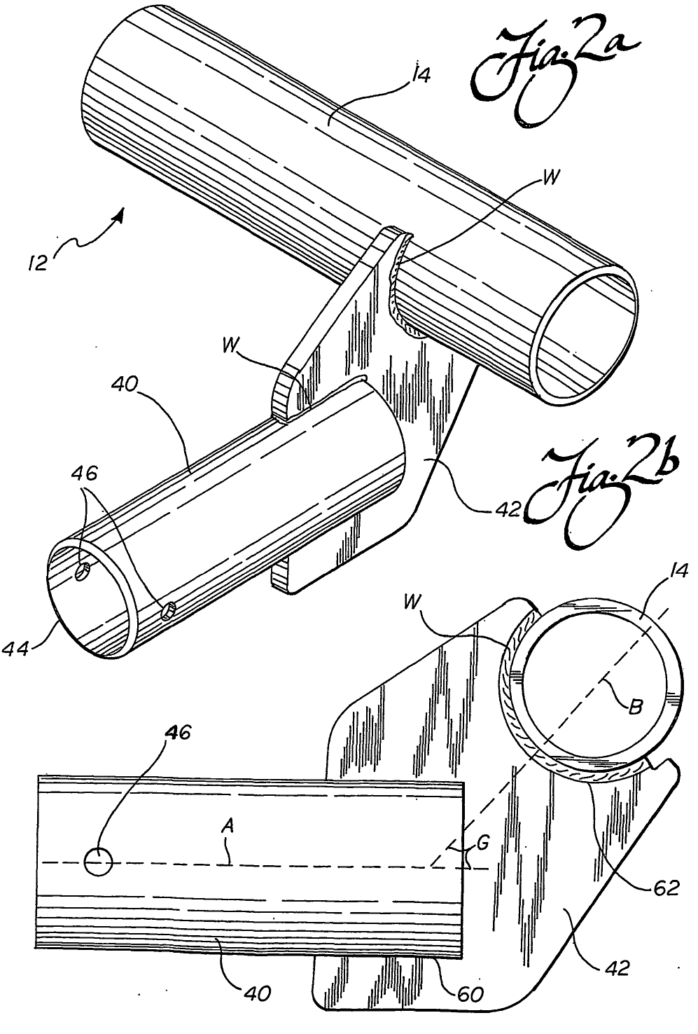

Reference is now made to FIGS. 2a and 2b which illustrate in detail the accessory receiver mounting bracket 42. The mounting bracket 42 comprises a mounting plate having a first slot 60 for receiving the accessory receiver 40 and a second slot 62 for receiving a tubular section 14 of the central frame member 12. Thus, where the receiver 40 is circular in cross section, the first slot 60 is rectangular in shape and where the tubular section 14 of the central frame member 12 is circular in cross section, the second slot 62 is semicircular in shape. Of course, the slots 60, 62 are shaped to correspond to the shape of the receiver 40 and tubular section 14 of the central frame member 12, respectively, no matter what shape they assume. Weld beads illustrated at W complete the connection of the receiver 40, the mounting bracket 42 and the tubular section 14.

In order to provide the desired upward orientation and projection of the receivers 40 on the central frame member 12, the slots 60, 62 are provided in a particular orientation best illustrated in FIG. 2b. As illustrated, the first slot 60 includes a first axis of symmetry. The second slot 62 includes a second axis of symmetry. Lines A and B extending along these axes of symmetry define an included angle G of between about 20° to about 60° and more typically about 45° to about 50°.

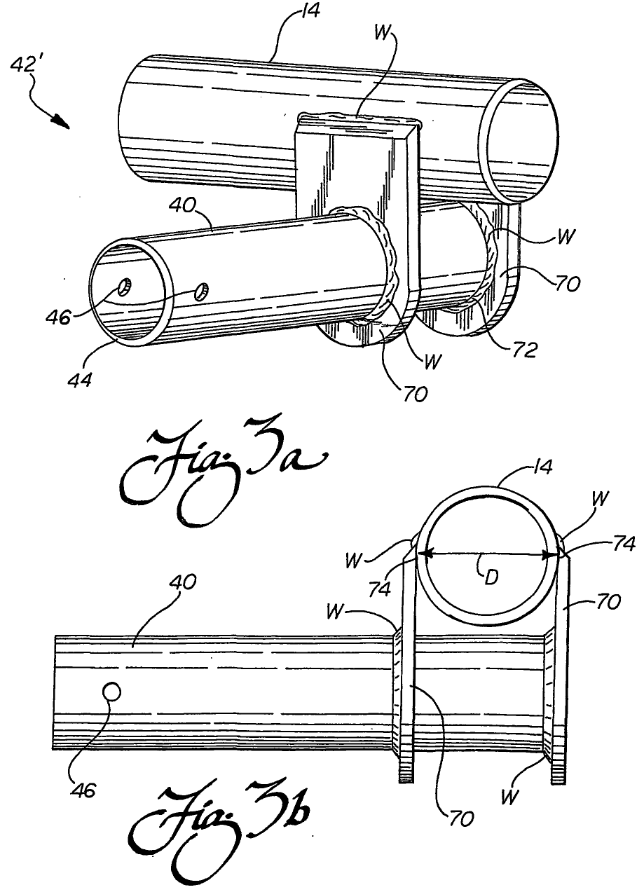

An alternative embodiment that may be substituted in place of the mounting bracket 42 shown in FIGS. 1, 2a and 2b is illustrated in FIGS. 3a and 3b. This mounting bracket 42′ comprises a pair of cooperating mounting plates 70. Each of the mounting plates 70 includes an aperture 72 for receiving and engaging the accessory receiver 40.

As illustrated in FIGS. 3a and 3b, the tubular section 14 of the central frame member 12 has an outer dimension D. The pair of cooperating plates 70 are spaced apart a distance D corresponding to the outer dimension D of the tubular section 14. In this manner the pair of cooperating plates 70 engage opposing points 74 on the tubular section 14 of the central frame member 12. Where the plates 70 are formed from steel like the accessory receiver 40 and the tubular section 14, weld beads W may be utilized to complete the connection of these component parts.

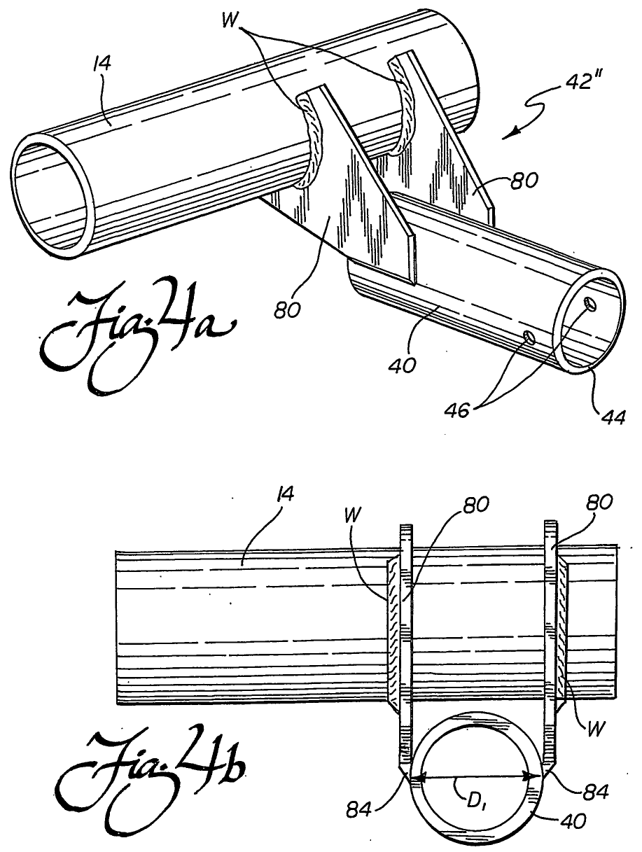

Yet another embodiment of the accessory receiver mounting bracket 42″ is shown in FIGS. 4a and 4b. The mounting bracket 42″ of this embodiment is a pair of cooperating mounting plates 80. Each of the mounting plates 80 includes a first slot 82 for receiving and engaging the tubular section 14 of the central frame member 12. Where that tubular section is circular the configuration of the slot 82 is semicircular or circular. Of course, it should be appreciated that the slot 82 is configured to match at least a portion of the peripheral outline of the tubular section 14 regardless of its configuration or shape (e.g., square, rectangular, hexagonal, elliptical).

In the illustrated embodiment the accessory receiver 40 has an outer dimension D₁. The pair of cooperating plates 80 are spaced apart a distance D₁ corresponding to the outer dimension D₁ of the accessory receiver 40. Thus, the cooperating plates 80 engage opposing points 84 on the accessory receiver 40. Where the plates 80 are constructed from steel, weld beads W may be provided to complete the secure connection between the accessory receiver 40, the mounting bracket 42″ and the tubular section 14 of the central frame member 12.

The foregoing description of three possible embodiments of the invention has been presented for purposes of illustration and description. It is not intended to be exhaustive or to limit the invention to the precise form disclosed. Obvious modifications or variations are possible in light of the above teachings.

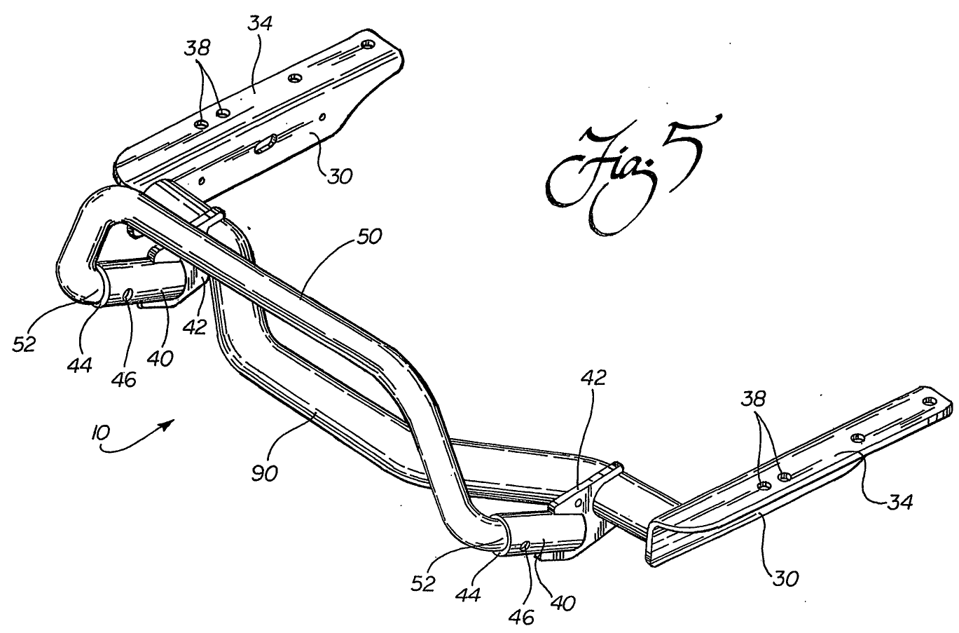

For example, embodiments may be provided without the hitch receiver box. As illustrated in FIG. 5, such an embodiment may include a single piece central frame member or cross bar 90 if desired. While not useful for towing a trailer such embodiments allow one to transport and utilize various accessories in a convenient and efficient manner. Further, such an assembly is suitable for use on smaller, relatively low power vehicles that are not suited for trailer towing but are capable of accommodating and transporting a desired accessory.

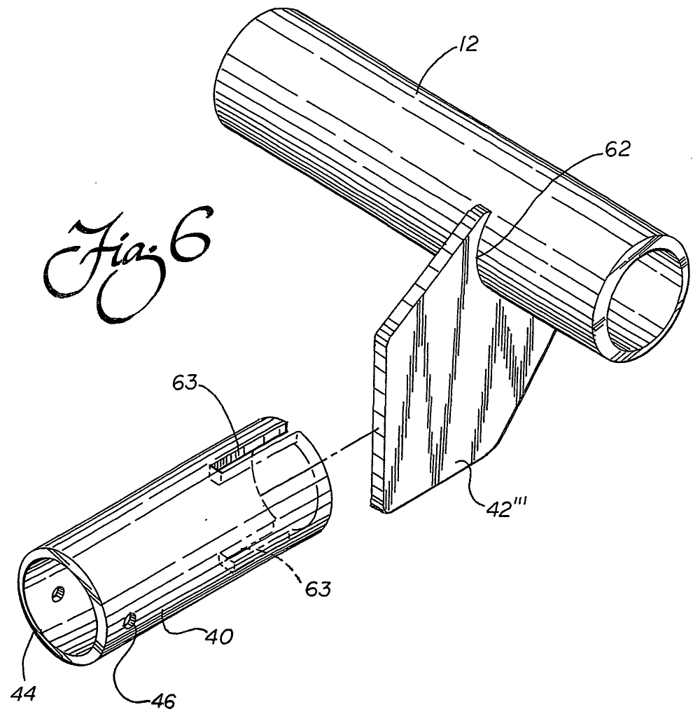

In accordance with still another possible embodiment, as shown in FIG. 6, the accessory mounting bracket 42′″ may only include a slot 62 for engaging the outer wall of the central frame member 12. In this configuration, the wall of the receiver 40 includes a pair of slots 63 for receiving the body of the bracket 42′″. Where all component parts 42′″, 40 are steel, the connection may be completed by welding.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An assembly for mounting an accessory to a vehicle, comprising:
a central frame member;
a pair of vehicle mounting brackets carried on said central frame member;
a first accessory receiver; and
a first accessory receiver mounting bracket secured to said first accessory receiver as well as to said central frame member between said pair of vehicle mounting brackets.

2. The assembly of claim 1, wherein said first accessory receiver mounting bracket is a mounting plate having a first slot for receiving said first accessory receiver and a second slot for receiving said central frame member.

3. The assembly of claim 2, wherein said first slot is rectangular and said second slot is semicircular.

4. The assembly of claim 3, wherein said first slot includes a first axis of symmetry and said second slot includes a second axis of symmetry wherein lines A and B extending through said axes of symmetry define an included angle of between about 20° to about 60°.

5. The assembly of claim 3, wherein said first slot includes a first axis of symmetry and said second slot includes a second axis of symmetry wherein lines A and B extending through said axes of symmetry define an included angle of between about 45° to about 50°.

6. The assembly of claim 1, wherein said first accessory receiver mounting bracket is a pair of cooperating mounting plates, each of said pair of cooperating mounting plates including an aperture for receiving and engaging said first accessory receiver.

7. The assembly of claim 6, wherein said central frame member has an outer dimension D and said pair of cooperating plates are spaced apart a distance D corresponding to said outer dimension D whereby said pair of cooperating plates engage opposing points on said central frame member.

8. The assembly of claim 1, wherein said first accessory receiver mounting bracket is a pair of cooperating mounting plates, each of said pair of cooperating mounting plates including a first slot for receiving and engaging said central frame member.

9. The assembly of claim 8, wherein each said first slot is semicircular.

10. The assembly of claim 8, wherein said first accessory receiver has an outer dimension D₁ and said pair of cooperating mounting plates are spaced apart a distance D₁ corresponding to said outer dimension D₁ whereby said pair of cooperating plates engage opposing points on said first accessory receiver.

11. The assembly of claim 1, further including a second accessory receiver and a second accessory receiver mounting bracket secured to said second accessory receiver as well as to said central frame member between said pair of vehicle mounting brackets.

12. The assembly of claim 11, wherein said second accessory receiver mounting bracket is a mounting plate having a first slot for receiving said second accessory receiver and a second slot for receiving said central frame member.

13. The assembly of claim 12, wherein said first slot is rectangular and said second slot is semicircular.

14. The assembly of claim 13, wherein said first slot includes a first axis of symmetry and said second slot includes a second axis of symmetry wherein lines A and B extending through said axes of symmetry define an included angle of between about 20° to about 60°.

15. The assembly of claim 13, wherein said first slot includes a first axis of symmetry and said second slot includes a second axis of symmetry wherein lines A and B extending through said axes of symmetry define an included angle of between about 45° to about 50°.

16. The assembly of claim 11, wherein said second accessory receiver mounting bracket is a pair of cooperating mounting plates, each of said pair of cooperating mounting plates including an aperture for receiving and engaging said second accessory receiver.

17. The assembly of claim 16, wherein said central frame member has an outer dimension D and said pair of cooperating plates are spaced apart a distance D corresponding to said outer dimension D whereby said pair of cooperating plates engage opposing points on said central frame member.

18. The assembly of claim 11, wherein said second accessory receiver mounting bracket is a pair of cooperating mounting plates, each of said pair of cooperating mounting plates including a first slot for receiving and engaging said central frame member.

19. The assembly of claim 18, wherein each said first slot is semicircular.

20. The assembly of claim 18, wherein said second accessory receiver has an outer dimension D₁ and said pair of cooperating mounting plates are spaced apart a distance D₁ corresponding to said outer dimension D₁ whereby said pair of cooperating plates engage opposing points on said second accessory receiver.

21. The assembly of claim 1, wherein said first accessory receiver has a first slot engaging said first accessory receiver mounting bracket and said first accessory receiver mounting bracket has a second slot engaging said central frame member.

22. The assembly of claim 21, wherein said first slot is rectangular and said second slot is semicircular.

23. The assembly of claim 22, wherein said first slot includes a first axis of symmetry and said second slot includes a second axis of symmetry wherein lines A and B extending through said axes of symmetry define an included angle of between about 20° to about 60°.

24. The assembly of claim 22, wherein said first slot includes a first axis of symmetry and said second slot includes a second axis of symmetry wherein lines A and B extending through said axes of symmetry define an included angle of between about 45° to about 50°.

25. The assembly of claim 1, wherein said assembly further includes a hitch receiver box carried on said central frame member.
